(19) United States
(12) Patent Application Publication
(10) Pub. No.: US 2014/0127746 A1
(43) Pub. Date: May 8, 2014

(54) SYSTEM FOR HANDLING BIOLOGICAL SAMPLES

(71) Applicants: Xenia M. Kachur, Tucson, AZ (US); Mark Banister, Tucson, AZ (US)

(72) Inventors: Xenia M. Kachur, Tucson, AZ (US); Mark Banister, Tucson, AZ (US)

(21) Appl. No.: 14/127,463

(22) PCT Filed: Jun. 21, 2012
(86) PCT No.: PCT/US12/43619

§ 371 Date: Dec. 18, 2013

Related U.S. Application Data
(60) Provisional application No. 61/564,416, filed on Nov. 29, 2011.
(60) Provisional application No. 61/499,405, filed on Jun. 21, 2011.

(51) Int. Cl. G01N 1/36

(52) U.S. Cl. CPC G01N 1/36
USPC 435/40.52; 422/536

(57) ABSTRACT

Improved specimen containers, methods and materials for use in connection with excised tissues are described.

The present invention relates generally to handling and preservation of biological samples, and more particularly to specimen containers, methods and materials for use in connection with surgical biopsies or other forms of biological samples. The invention has particular utility in connection with surgical breast biopsies and will be described in connection with such utility, although other surgical biopsy utilities as well as other biologic sample utilizes are contemplated.

Residual breast cancer detected at the margins of excised breast specimens indicate a local breast cancer recurrence rate of up to 25%, 3 to 5 years after breast conservation surgery and radiotherapy, as compared with 3.7% when negative, or clear, margins are obtained. The risk of breast cancer recurrence can be reduced by removing more normal tissue surrounding the tumor; however, cosmetic results are adversely affected by larger volume excision. Specimen x-ray imaging is used as a reliable method for assessing margins of excised breast specimens in order to balance between risk of local recurrence, avoiding multiple re-excisions and psychological issues associated with it, cost, and acceptable cosmesis.

Detection of small, nonpalpable breast lesions has been greatly facilitated in recent years by the use of x-ray, mammography and/or sonography procedures. However, identification of a suspicious lesion does not establish its exact extent within the breast. Heretofore, needle location of suspicious lesions using radiology has been a common approach. Some special variations have also been employed including a modified needle/hook wire technique.

Once the cancerous tissue is excised from a patient, steps must be taken to insure that the entirety of the diseased tissue has been removed and to guide subsequent treatment protocols. Typically, once the tumor has been excised, the surgeon orients the specimen using either orientation clips or sutures and x-rays the specimen to confirm tumor inclusion. The specimen is then given to a pathologist who removes the orientation clips or sutures, and manually places six colors of differential ink on the areas of the specimen corresponding to specific orientation directions. The pathologist then sections the specimen to examine each slice for healthy margin. Other difficulties include excessive specimen compression, single-dimensional imaging, non-reproducible specimen sectioning and lack of proper specimen fixation.

Currently there are no available specimen containers for breast-conserving surgery that offer a mechanism for x-ray imaging specimens in two planes. Yet, two-plane or two-view x-ray imaging has an advantage of yielding additional margin information which in turn may result in reduced repeat surgery rates.

Furthermore, surgical excision has, in the past, resulted in several interrelated difficulties that contribute to inefficiency and inaccuracy. These difficulties include the fact that location of the lesion within the specimen, as well as the location of the specimen within the anatomy prior to excision, are complicated by movement of the specimen on the x-ray film during transportation to pathology and during the pathological analysis. Further, this technique requires an extended period of anesthesia for the patient and is subject to inaccuracies and inconsistencies in the interpretation and communication to the surgeon of the pathologist's findings.

There is thus a need for an apparatus and materials to secure the specimen during the transportation and pathological analysis in relation to a precise location defined by radio-opaque coordinates superimposed on the x-ray. In addition, the use of a fixed orientation and radio-opaque coordinates for the excised specimen on the x-ray is extremely beneficial to the pathologist in localization of suspicious lesions within the specimen to avoid a possible misdiagnosis.

It is thus an object of the present invention to provide an improved specimen container, embedding materials and processes that addresses the aforesaid and other limitations of prior art systems. More particularly, in accordance with the present invention, we provide, in one aspect, a novel and improved specimen container, novel and improved embedding materials, and novel and improved processes for use in connection with excised tissue samples. More particularly, in accordance with one aspect of the present invention, there is provided a specimen container having one or more tissue anchors designed to hold the specimen in place. The interior walls of the specimen container are provided with contours providing specimen orientation information. The specimen container is formed of an x-ray transparent material and is liquid tight to hold a liquid gel embedding material.

In one embodiment of the invention there is provided an excised tissue container or biopsy container having a hollow for receiving and retaining a tissue specimen for treatment with an embedding material preparatory to histological examination. The container has a bottom wall and sidewalls hingedly affixed to the bottom wall. The bottom wall and at least two of the sidewalls have different contours which serve as orientation markers and/or sectioning markers or guides. The bottom wall further comprises a tissue anchor extending therefrom for temporarily holding a tissue specimen.

In another embodiment, the excised tissue container includes radio opaque indicia markings on the sidewalls of the container. Preferably the indicia markings include markings of superior, inferior, lateral and medial sides.

Also, if desired, the excised tissue container interior bottom wall may include radio opaque fiducial markings.

In one embodiment, the tissue anchor is formed integrally with the bottom wall.

In another embodiment, the tissue anchor comprises a separate element that is fixed to the bottom wall. In such embodiment, the tissue anchor may be fixed to the bottom wall in a bayonet-type fitting.

In a preferred embodiment, the sidewalls of the container are joined to one another along their edges along frangible tear lines.

In yet another embodiment, the excised tissue container includes orientation pegs extending from three of the sidewalls to differentiate the sidewalls from one another.

In another embodiment of the invention there is provided a gel formulation for use as an encapsulate for a tissue sample, wherein the gel formulation is a substantially radio transparent epoxy having a maximum setting temperature below about 54° C.

Preferably, the gel formulation has a setting time of not more than about 10 minutes, more preferably a setting time of not more than about 4-5 minutes.

In one embodiment of the invention, the gel formulation comprises a mixture of an epoxy resin, a polyimine and a carrier.

In another embodiment of the invention, the gel formulation comprises an exopxy resin comprising a di-epoxide and a polyimide comprising a branched polymer with imide at terminal ends of the branches.

In one embodiment, the gel formulation comprises a mixture of poly(ethyleneglycol) diglycidyl ether, poly(ethyleneimine) and water.

In another embodiment, the gel formulation comprises a mixture of poly(ethyleneglycol) diglycidyl ether, poly(ethyleneimine) and formalin.

In another embodiment, the gel formulation comprises a mixture of ethylene glycol digycidyl ether epoxide, a branched or endcapped ethyeneimine ethylenediamine polymer, and formalin.

The present invention also provides a method for preparing a biological sample for pathologic analysis, which comprises soaking the biologic sample in a mixture of a carrier transport solution such as dimethyl sulfoxide (DMSO)/formalin solution prior to placing the biologic sample into one of the gel compositions as above described.

In yet another embodiment, after allowing the gel to set, the sample is sliced, soaked in xylene for a period of time, and then soaked in melted paraffin for a period of time to allow paraffin penetration.

In use, a specimen is placed properly orientated in the container, and temporarily held in position on the spike. A liquid gel embedding material is then poured into the container and allowed to set to fix the specimen in its orientation. Alternatively, the liquid gel material may be added to the container, and the specimen is then placed in the container. The liquid gel embedding material may comprise, for example, a conventional paraffin wax, molten nitrocellulose, gelatin or other commercially available resins that have been used to embed specimens in desired orientation. However, in a preferred embodiment of the present invention, the embedding material comprises a novel epoxy encapsulate that allows fixation and preservation of the sample at ambient temperatures. The sample can then be processed through industry standard histology processes as will be described below.

Further features and advantages of the present invention will be seen from the following detailed description, taken in conjunction with the following drawings, wherein like numerals depict like parts, and wherein

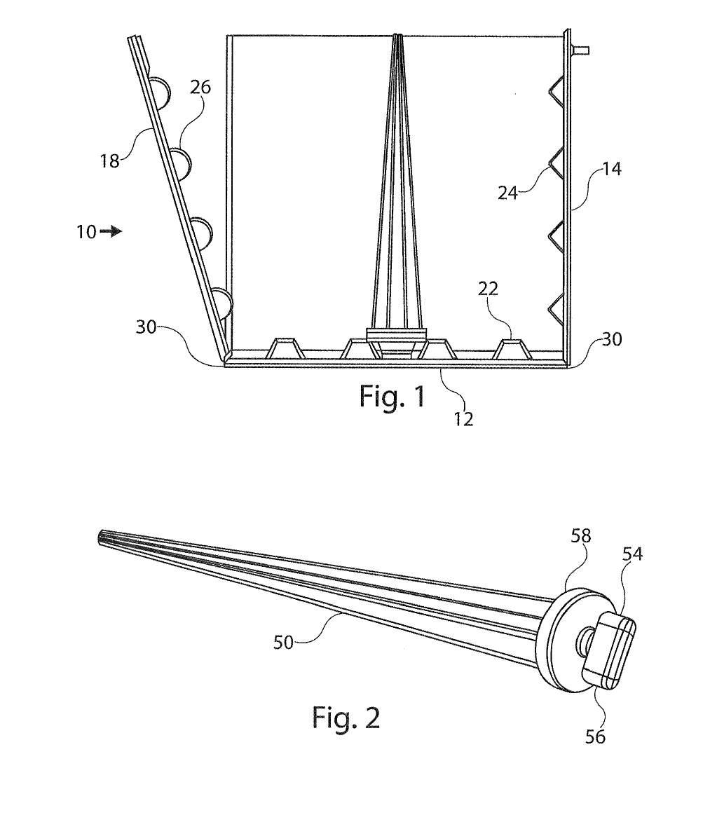

FIG. 1 is a cross-sectional view of a first embodiment of a specimen container made in accordance with the present invention;

FIG. 2 is a perspective view of an independently molded spike element of the specimen container of FIG. 1;

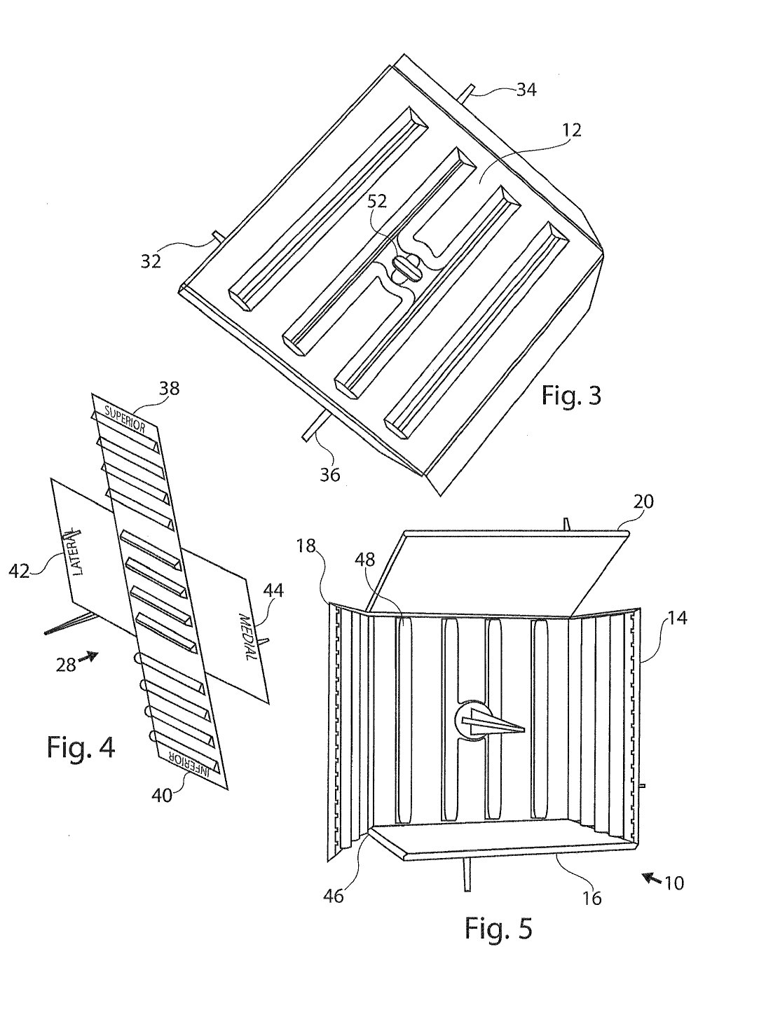

FIG. 3 is a bottom plan view of the specimen container of FIG. 1;

FIG. 4 is a perspective view of a molded blank used to form the specimen container of FIG. 1;

FIG. 5 is a perspective view, from the top, showing the specimen container of FIG. 1 during assembly; and

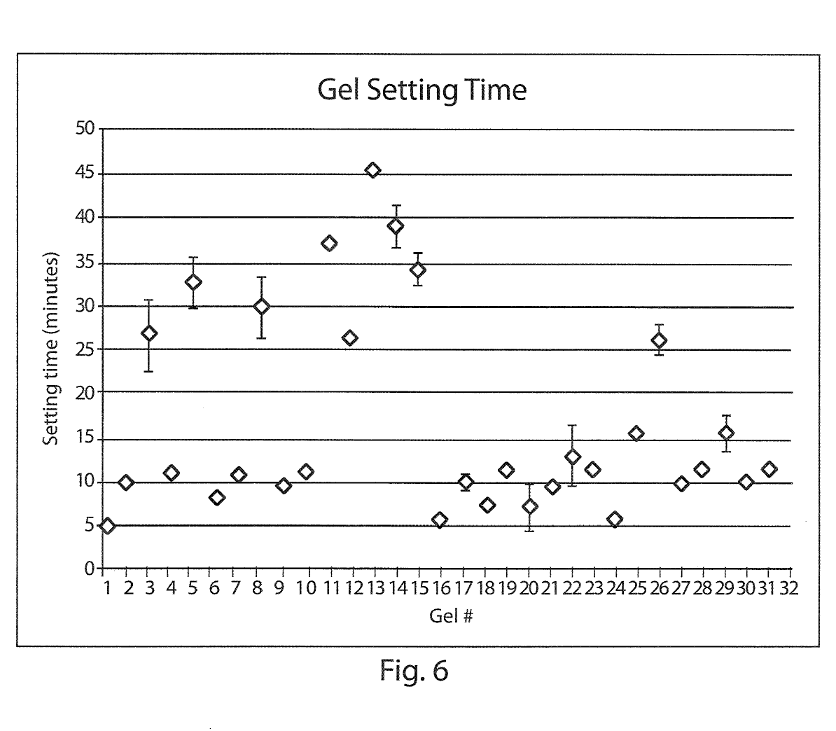

FIGS. 6-10 are graphs of gel setting times.

Referring to FIGS. 1-5, the specimen container in accordance with the present invention provides a generally cube-shaped open container 10 having a base 12 and sidewalls 14, 16, 18 and 20. Formed on the interior of the base 12, and at least two of the sidewalls, e.g., 14 and 18, respectively, are contours 22, 24, 26. Contours 22, 24 and 26 are equally spaced from one another, for example, every five mm. Preferably contours 22, 24 and 26 have different contours, i,e., so as to serve as orientation markers. Contours 22, 24, 26 also may serve as sectioning markers or guides for a pathologist.

Referring in particular to FIG. 5, container 10 is formed from a molded blank 28, formed of an x-ray transparent plastic. The bottom 12 and sidewalls 14, 16, 18 and 20, are connected to one another by thin living hinges 30.

Orientation pegs 32, 34, 36 are molded on and extending from three of the walls, e.g., 14, 16 and 18. Orientation pegs 32, 34, 36 have different lengths to differentiate the walls from one another.

Radio-opaque indicia 38, 40, 42, 44 are provided on the sidewalls 14, 16, 18, 20 providing orientation markings of superior, inferior, lateral and medial sides. Additionally, radio-opaque fiducial markers 46, 48 are provided on the bottom 12 for permitting localization of internal structures. As will become apparent from the description following, contours 22, 24, 26 become molded into the surfaces of the embedding material, providing proper orientation and sectioning guides for a pathologist.

Referring in particular to FIG. 2, a tissue anchor 50 is provided for temporarily holding a specimen in a desired position. Tissue anchor 50 extends from the bottom 12. Tissue anchor 50 may be molded integrally with the bottom 28. Preferably, however, tissue anchor 50 is molded separately and is fitted into a hole 52 in bottom 12 and locked in place with two protruding wedges 54, 56 in a bayonet-type fitting.

A disc portion 58 adjacent the lower end of tissue anchor 50 covers hole 52 sealing the hole against leakage. Alternatively, tissue anchor 50 may be replaced with a plug.

The container is assembled from blank 28 by folding up the sidewalls 14, 16, 18, 20 and joining the sidewalls together at their edges, for example, using water-resistant clips or an adhesive or glue. A feature and advantage of the present invention is that the sidewalls are frangible along their adjoining edges, so that the sidewalls may be folded back and a sample removed, e.g., for sectioning.

As noted supra, the specimen container of the present invention may be employed with a variety of embedding materials including paraffin waxes, molten nitrocellulose, gelatin, and various resins to hold the specimen in a desired orientation.

Embedding materials must satisfy several criteria. For one, the embedding materials should be essentially x-ray transparent, or at least minimally x-ray absorbing so as to not interfere with assessment of cancerous legions in the tissue using radiography. Also, embedding materials should have as little possible effect on down-stream tissue processes such as fixation, dehydration, paraffin penetration or subsequent staining of the tissue. Other criteria include fast setting times and low temperature setting, i.e., so as to not denature or otherwise change the tissue. In accordance with the present invention, we have provided certain novel gel formulations involving epoxy encapsulates that allow embedding and preservation of biological samples essentially at ambient temperatures, that meet the aforesaid criteria. Additionally, unexpectedly, we found that these materials may act as a preservation agent for fresh tissue. This latter property is particularly advantageous in rural and third-world communities and military locations where samples may not be analyzed immediately after harvesting. More particularly, we have discovered certain novel gel formulations involving epoxy encapsulates meeting the aforesaid criteria that allow embedding and preservation of biological samples essentially at ambient temperatures.

Preferred epoxy gels in accordance with the present invention comprise two reaction components, a di-epoxide and a branched polymer with imines at the terminal ends of the polymer branches. The reaction may be accelerated by the addition of water or other solvent such as formalin solution. If desired, an alcohol soluble, xylene soluble and/or raylene substitute soluble crosslinker may be added to the epoxy gel.

The epoxy forms a gel that can be used to encapsulate a tissue sample, a biopsy section or other biological sample such as but not limited to a cancer removal section such as a breast lumpectomy or an internal organ section.

In a preferred embodiment of the invention, the epoxy components are mixed together in a container 10 to start the epoxy reaction, then the biological sample is placed into the epoxy formulation in the desired orientation on the tissue anchor and the epoxy formulation is allowed to gel or harden. Alternatively, the biological sample may be placed in the container in the proper orientation with or without the tissue anchor, and the epoxy formulation which is pre-mixed in another container, poured into the container 10 to cover the sample, and allowed to gel or harden. Once the epoxy formulation has gelled or hardened the sample is processed as needed, it can be stored as is for an extended time period with or without refrigeration, it can be sliced for immediate analysis, it can be sliced and processed for paraffin penetration and sliced for analysis under a microscope using normal histology procedures.

In one embodiment, the gel formulations consist of the following two polymers: poly(ethylene glycol) diglycidyl ether (PEGDE) and poly(ethyleneimine) (PEI), with water used as a solvent. Poly(ethylene glycol) diglycidyl ether is a derivative of the poly(ethylene glycol) group and has the chemical structure given below. This group of polymers has found numerous uses and applications due to its water solubility, hydrophilicity, physiological inactivity, low toxicity, and stability under varying chemical conditions.

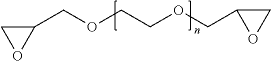

Poly(ethyleneimine) (PEI) is an organic polymer that contains a high density of primary amines. Its polycationic nature lends itself to various biological applications such as cell attachment promoters, transfection reagents, and as cytotoxicity agents. When combined with water, the PEGDE and. PEI crosslink to form a biocompatible, ductile gel that is very suitable for use as an embedding material in accordance with the present invention.

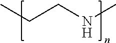

Varying the fraction of reactive components affects the hydrolytic instability of the hydrogels, brittleness, and equilibrium swelling ratio. The polymeric chemical reaction, shown below, is a result of the oxygen groups on the poly(ethylene glycol) chains reacting with the amines resulting in an exothermic cross-linking. We used a similar method of component variation in order to use the reaction to optimize properties for use as an embedding material.

Using procedures as described below, we identified particular gels of interest, which set in not more than 4-5 minutes, and reached maximum setting temperatures below 54° C. Since the reaction is exothermic, it is important to limit the reactants to those which reach a maximum setting temperature below 54° C., in order to prevent possible damage or change of the tissue sample.

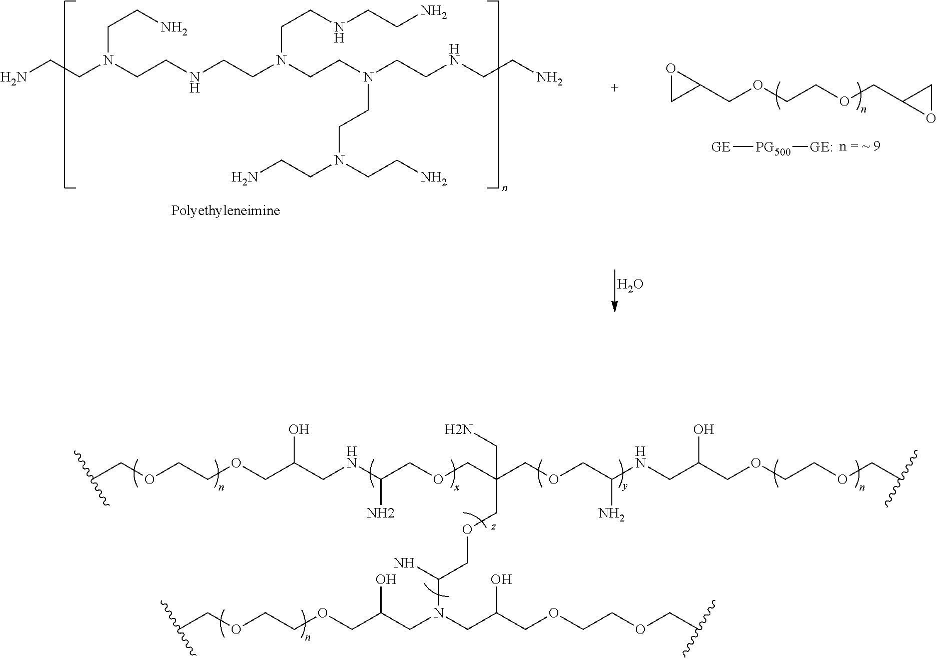

The purpose of a gel formulation is to:
(1) Allow fast and accurate orienting of the specimen in the operating room.
(2) Facilitate uncompressed suspension of the tumor specimen during radiography.
(3) Provide support for the specimen during sectioning.
(4) Maintain orientation information for the pathologist throughout the tissue processing steps.

As noted supra, the gel is designed to set at essentially ambient temperatures not exceeding about 54° C., into a hardened but moderately ductile gel, within minutes after being mixed, the entire device with specimen and gel can then be radiographed, from various orientations, without introducing false-positive margins caused by excessive compression.

Following radiography, the device is transported to the pathologist. The walls of the hardware are torn apart and folded down and the 5 mm-spaced sectioning guides that are embedded in the gel act as a guide, allowing the pathologist to cut thin even slices through the tissue and gel material. Once the specimen margins are evaluated, the entire tumor and surrounding gel can be sent for fixation, processing, and analysis.

The gel properties of greatest importance are the time in which it takes the gel to set, or harden, and the maximum temperature reached during the epoxy curing reaction. The present invention not only increases the accuracy of the procedure but also minimizes the amount of time, and therefore cost, necessary to determine intraoperative margin status, without damaging the tissue sample by staying below the critical temperature.

We designed a study for the purpose of narrowing down the options for gel formulations that would be suitable for optimal device functionality. As aforementioned, the function of the gel itself is to suspend the excised cancerous tissue specimen via encapsulation for two purposes: (1) to orient the specimen for gross pathology analysis and (2) allow for uncompressed 2-plane x-ray imaging of the tumor.

For the purpose of orienting the specimen, the gel property of greatest interest is the setting time. A major factor that is always taken into account in surgical procedures is operating room time, due to both patient safety and cost. Because many surgeons opt to get intraoperative assessments of breast-conserving surgery (BCS), the amount of time that it takes the gel to set is of utmost importance.

Based on our observations of the pathologists' inking and sectioning process in the operating room, the current process takes between 10-25 minutes depending on the tissue size and consistency, the physician's experience, how the surgeon has oriented the specimen, choice of sectioning modality, and other factors. The device of the instant invention not only aims to remove sources of human error, such as multiple persons orienting a specimen, but also to shorten the amount of time necessary in the operating room. We have identified certain gels with properties that would enable this.

We began by outlining 32 target gel formulations, varying both the volumes of the components as well as the chain lengths of the two polymer components, as outlined in Table I below:

TABLE I
Gel formulations with the chain lengths and volumes tested.

| | PEI chain | PEGDE chain | PEI | PEGDE | H2O |
|---|---|---|---|---|---|
| Gel # | length | length | (g) | (g) | (g) |
| 1 | 1200 | 526 | 7 | 5 | 6.5 |
| 2 | 1200 | 600 | 7 | 5.9 | 7 |
| 3 | 1200 | 1000 | 7 | 9.5 | 6.5 |
| 4 | 1200 | 600 | 8.4 | 5.7 | 7 |
| 5 | 1200 | 1000 | 8.4 | 9.5 | 6.5 |
| 6 | 1800 | 526 | 9.33 | 5 | 6.5 |
| 7 | 1800 | 600 | 9.33 | 5.7 | 6.5 |
| 8 | 1800 | 1000 | 9.33 | 9.5 | 6.5 |
| 9 | 1800 | 526 | 11.6 | 5 | 6.5 |
| 10 | 1800 | 600 | 11.6 | 5.7 | 6.5 |
| 11 | 1800 | 1000 | 11.6 | 9.5 | 6.5 |
| 12 | 1200 | 1000 | 8.4 | 7.6 | 6.5 |
| 13 | 1800 | 1000 | 11.6 | 7.6 | 6.5 |
| 14 | 1200 | 1000 | 8.4 | 6 | 6.5 |
| 15 | 1800 | 1000 | 11.6 | 6 | 6.5 |
| 16 | 800 | 526 | 3.5 | 5 | 8.5 |
| 17 | 800 | 600 | 3.5 | 5.7 | 8.7 |
| 18 | 800 | 600 | 4.2 | 5.7 | 8.5 |
| 19 | 800 | 600 | 3.5 | 5.7 | 10.1 |
| 20 | 800 | 526 | 4.2 | 5 | 8.5 |
| 21 | 800 | 600 | 4.2 | 5.7 | 8.5 |
| 22 | 800 | 600 | 4.2 | 5 | 8.5 |
| 23 | 800 | 600 | 5.1 | 5 | 10.1 |
| 24 | 800 | 600 | 4.2 | 5 | 8.5 |
| 25 | 1800 | 600 | 11.6 | 4.7 | 7.6 |
| 26 | 1200 | 600 | 9.3 | 4.7 | 7.6 |
| 27 | 1200 | 526 | 8.7 | 7.5 | 3.5 |
| 28 | 1200 | 600 | 8.7 | 5 | 5 |
| 29 | 1200 | 600 | 8.7 | 8 | 3.5 |
| 30 | 800 | 600 | 4 | 5.7 | 8.5 |
| 31 | 800 | 600 | 4.5 | 4.5 | 8.5 |
| 32 | 800 | 600 | 5 | 5 | 8.5 |

A plastic baggy was placed into a 100 mL beaker in order to prevent the gel from sticking to the glass walls. Respective volumes of the components were then added to the beaker, PEI being added first followed by PEGDE, and then lastly water. The contents of the baggy were all stirred for approximately 30 seconds and a timer was started. A thermometer was placed into the center of the mixture and the beginning and peak temperatures were recorded. Once the gel fully set, as confirmed by manual prodding of the surface, the gel was removed from the baggy and beaker then cut in half to confirm the center of the formulation was set as well. This was repeated four times for each gel formulation.

The results of the setting times and peak temperatures reached shown in FIG. 6.

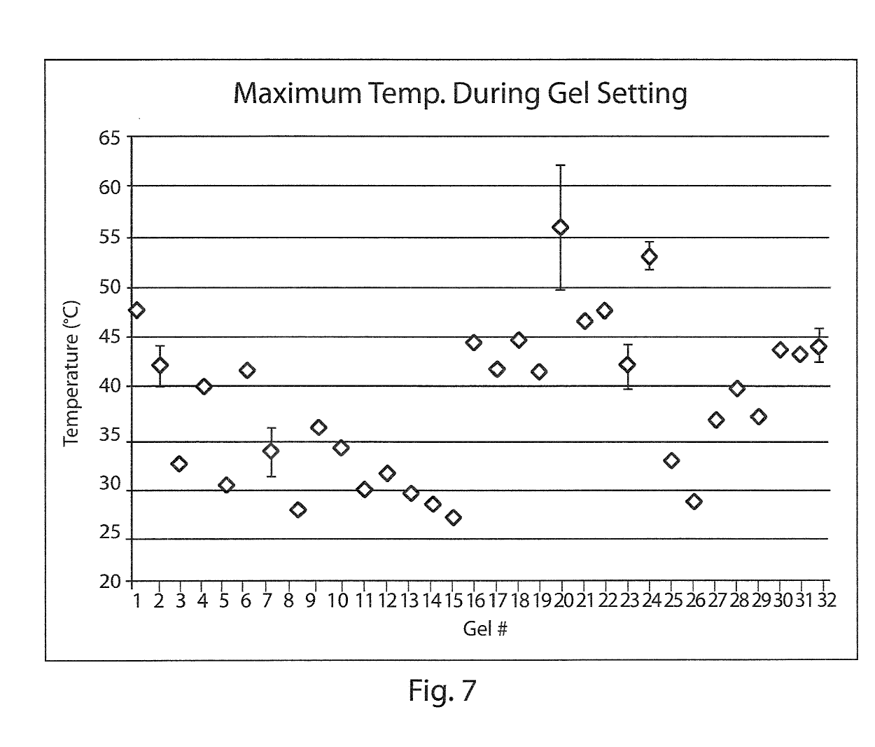

FIG. 7 demonstrates the wide range of setting times from approximately 5-45 minutes. As previously described, the aim is to identify the gels that have the potential to shorten the current process of intraoperative assessment; therefore, the gels of most interest are those setting under 10 minutes.

Temperature is also a significant factor to note due to the effect of thermal exposure on tissue. Notable thermal damage to human tissue varies with both the peak temperature and duration of the thermal exposure. The duration of the peak temperature while setting is no longer than 1 minute; therefore the maximum temperature that the gel may reach during setting is 54° C. Only gel formulation #20 reported peak temperatures above the threshold for tissue damage.

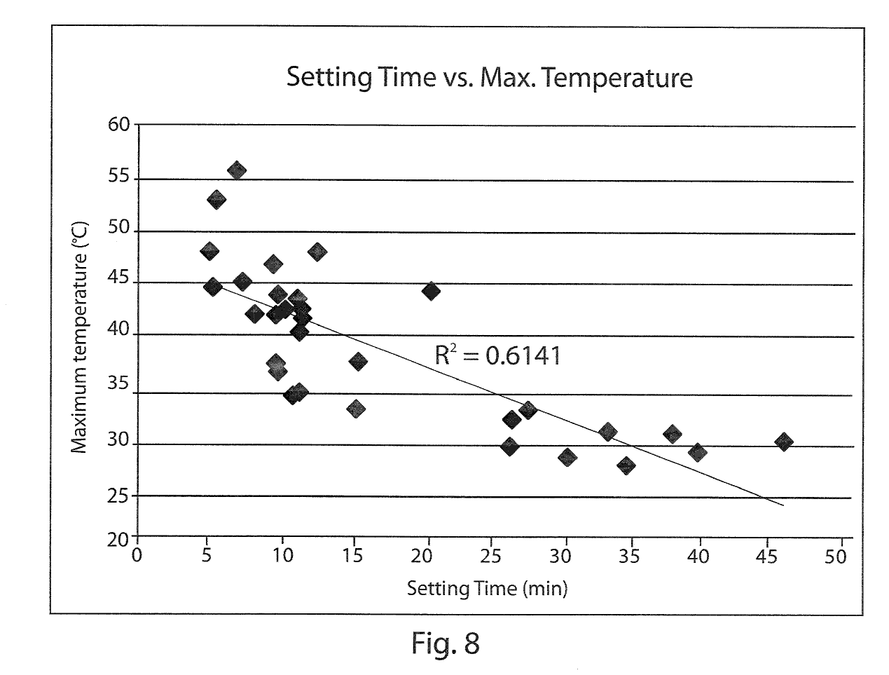

We also used the data to compare how setting time correlates to the peak temperature reached when the mixture is reacting. We found that there is a negative correlation; as the setting time increases, the peak temperature reached decreases, as illustrated in FIG. 8.

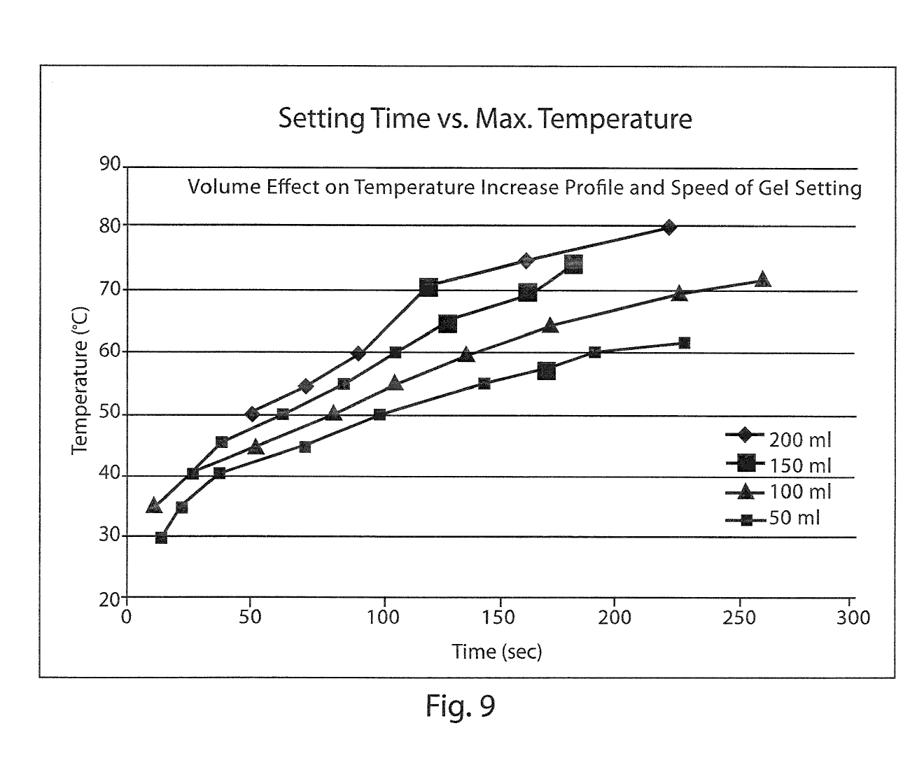

We hypothesized that the setting time is affected by the total volume of the gel mixture. We tested this by preparing a fast-setting gel, #16, at four different volumes and monitoring the temperature profiles at various time points. The formulations were mixed together by the same method as the previous setting time experiments with ratiometric increases in volume. The results are presented in FIG. 9. We found that as the total volume of gel decreases, the maximum temperature reached decreases and the setting time increases.

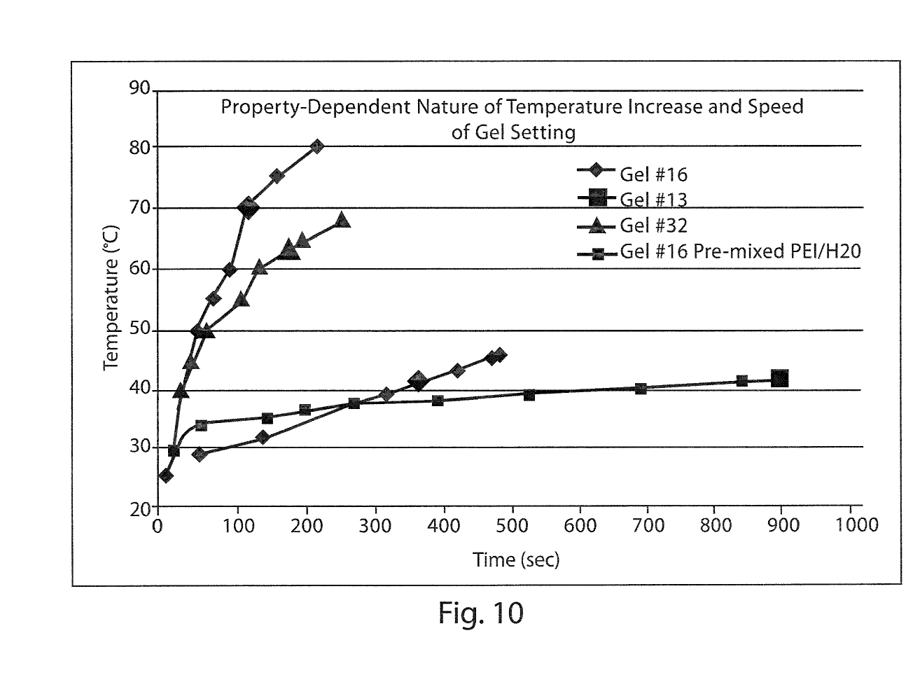

Because there is variation in the size of excised lumpectomies, there may be need to use different formulations for different sizes in order to ensure optimal set times with no thermal damage. The gel tested in FIG. 8 is not suitable for larger specimen volumes due to the potential thermal damage that could be caused during gel setting. We chose to examine other options for larger specimens. We tested two additional 200 ml formulations, #13 and #32, both of which had initial set times of over 25 minutes. In an effort to decrease the maximum temperature of the reaction, we also tested gel #16 again but changed the order in which we mixed the components together. We observed that mixing H₂O and PEI together caused an exothermic reaction, emitting heat. We therefore mixed these components together first, waited one minute, and then stirred in the PEGDE. The formulations' temperature profiles are plotted against time in FIG. 10.

Although setting very rapidly, gels #16 and #32 reached temperatures that are potentially damaging to tissues and therefore could not be used for specimens of this volume. Gel #13 peaked at relatively low temperature of 42° C. but it undesirable due to the length of reaction time. As predicted, Gel #16 with pre-mixing of H₂O and PEI, resulted in a slowed setting time of approximately 6 minutes, with a temperature that is suitable for tissue viability. These findings indicate that different gel formulations may be suitable for different volume applications and also that specific gel reactions can be slowed by changing the order in which the components are mixed.

We have also discovered certain other epoxy materials may advantageously be used as embedding materials in accordance with the present invention. Such materials are prepared by mixing together branched ethyleneimine polymers, ethylene glycol diglycidyl ethers and formalin solution. The resulting epoxy forms a gel that can be used to encapsulate a tissue sample, a biopsy section or other biological sample as above described.

Variants of the epoxy formulation include using either branched ethyleneimine, branched polyethyleneimine, or branched polyethylene ethylenediamine end-capped polymers. The ethyleneimine polymers and variants typically are available in both single and poly molecular weights of 500-120,000 through companies such as Sigma Aldrich. The ethylene glycoldiglycidyl ethers are available through suppliers such as Sigma Aldrich and Poly Sciences. These are also available in a variety of molecular weights from 100 to 1200 but for the purpose of this invention we found preferred embodiments have molecular weights greater than 200, and more preferably greater than 500, and even more preferably greater than 800. The formalin solution is typically available in aqueous solutions of 5% to 35% and may include stabilizers such as methanol. In certain preferred embodiments once the chemicals are mixed the set time can be 10 minutes or less dependent on the temperature and imine-to epoxide ratio, the higher the imine-to-epoxide ratio the faster the formulation will set, although set times are useful also. In general the longer the polymer chains the better the paraffin penetration of the epoxy material during the paraffin embedding steps of the biologic or tissue sample.

The addition of formalin to the epoxy gel also permits biotinylation of the biological sample. Formalin also advantageously may be employed before the gelling step. For example, a biologic sample may be soaked in a mixture of formalin solution, with another carrier transport component to facilitate fast transport across cell walls such as dimethyl sulfoxide (DMSO), or dimethyl formamide (DMF), or hyaluronic acid or combination of these. The biologic sample may then be placed into the epoxy gel and the epoxy allowed to polymerize and encapsulate the biological sample as above described. Also, once the biological sample is encapsulated as described above, the sample may be sliced and soaked in alcohol or xylene or xylene substitute for a period of time, and then soaked in melted paraffin for a period of time to allow paraffin penetration of the epoxy and biologic sample, and thereafter subjected to pathological analysis.

In addition to the formalin solution and the two epoxy components an additional crosslinker or stabilizer may be added to prevent yellowing of the polymer from the reactive imines. Additional crosslinkers that are soluble in alcohol, xylene or xylene substitutes such as naphthenic hydrocarbon blends or citrus based solvents may be added to promote paraffin penetration during manual or automated fixation and embedding procedures. Incorporating cross linkers that are soluble in the traditional histology paraffin embedding process offers the advantage of providing greater paraffin penetration of the epoxy encapsulate of the present invention, that is surrounding the tissue sample. This also improves the slicing stability of the epoxy encapsulate once embedded with paraffin. A further advantage of the described invention enables seamless integration into the current manual and automated fixation and paraffin embedding processing that is industry standard at many pathology and histology labs. In this process tissue samples are typically soaked in formalin for a set time period, usually 24-48 hours, samples are then soaked in several alcohol baths of increasing alcohol concentration followed by the final step of soaking the samples in xylene baths before immersing the samples in melted paraffin as the final paraffin embedding step.

Examples of alcohol soluble crosslinkers include nitrocellulose and polyvynil alcohol (PVA) polymers such as tris(hydroxymethyl)aminomethane, tris(hydroxymethyl)aminomethane hydrochloride, polyvinyl alcohol 22000, glycerol, and 1,4-diazabicyclo[2.2.2]octane PVA can also work well in a combination with the nitrocellulose. These are just two of many alcohol soluble that can be used and are not meant to limit the scope of the invention.

Examples of xylene soluble cross linkers are polypropylene containing polymers that will readily crosslink within the epoxy system of the present invention such as polypropylene glycol diglycidyl ether or O,O′-Bis(2-aminopropyl) polypropylene glycol-block-polyethylene glycol-block-polypropylene glycol. These are just two examples of many possible polypropylene polymer chain combinations with epoxy reactive end units both of which are available from Sigma Aldrich and other chemical suppliers in compatible formulations and chain lengths and arc not meant to limit the scope of the invention.

In yet another embodiment we use UV irradiation to facilitate crosslinking. In still yet another embodiment we incorporate a triglycidyl ether such as trimethylpropane or tris hydroxyphenyl methane, and these may be reacted via epoxidation with linear diamines, branched diamines and or triamines and or branched ethyleneimines.

In yet another embodiment the epoxy gel may be used to separate liquid components of a biologic sample such as urine or saliva or water while in the specimen container. When the epoxy absorbs a liquid, the components of the liquid may be screened according to the physical size of the component or polar attraction of the component. Liquid components arc screened or concentrated in areas where the porosity of the epoxy polymer matrix is smaller than the component in the liquid being absorbed. The epoxy may also have biological markers, dyes or hormones incorporated into the mixture that indicate for a particular disease state or substance such as a protein or antibody or drug. The epoxy formulations may also be used to preserve the liquid biologic samples and components of the liquid samples such as cells and proteins.

When using these various epoxy formulations, prior to epoxy encapsulation described above the biological sample may or may not be soaked either in formalin solution per standard histology methods or soaked in a carrier transport solution of dimethyl sulfoxide (DMSO) or dimethyl formamide (DMF) and formalin which allows for a much faster penetration of the formalin solution into the biological sample. Additionally, hyaluronic acids or salts also may be used to facilitate faster formalin transport across the cells of the biological sample.

The ability of the above described epoxy gel formulations to act as a preservation agent for fresh tissues, makes the gel formulations useful for preservation and transportation of all kinds of biological samples, as well as providing utility as a preservative for food and cosmetics. The gel formulations also may be used as an adhesive for biological products and/or for rapid dehydration of camping and military goods/foods, etc. The gels also may be employed as an acne medication, and may have the added function of acting as a peel, i.e., to clear pores.

Various changes may be made without departing from the spirit and scope of the invention. For example, dyes or stains or other chemical or biological agents such as hormones, preservatives, fungicides, bacteriocides, insect repellants, etc., could be added to the epoxy formulations. Also, to facilitate removal of the set gel from the container, a tab may be incorporated into the gel before the gel sets. Still other changes are contemplated.

1. An excised tissue container having a hollow for receiving and retaining a tissue specimen for treatment with an embedding material preparatory to histological examination, said container having a bottom wall and sidewalls hingedly affixed to the bottom wall, wherein said bottom wall and at least two of said sidewalls have different contours which serve as orientation markers and/or sectioning markers or guides, said bottom wall further comprising a tissue anchor extending therefrom for temporarily holding a tissue specimen.

2. The container of claim 1, further including radio opaque indicia markings on the sidewalls of the container.

3. The container of claim 2, wherein said indicia markings include markings of superior, inferior, lateral and medial sides.

4. The container of claim 1, wherein said interior bottom wall includes radio opaque fiducial markings.

5. The container of claim 1, wherein said tissue anchor is formed integrally with said bottom wall.

6. The container of claim 1, wherein said tissue anchor comprises a separate element that is fixed to said bottom wall.

7. The container of claim 6, wherein said tissue anchor is fixed to said bottom wall in a bayonet-type fitting.

8. The container of claim 1, wherein said tissue anchor is replaced by a plug.

9. The container of claim 1, wherein the sidewalls are joined to one another along their edges along frangible tear lines.

10. The container of claim 1, further including orientation pegs extending from three of the sidewalls to differentiate the sidewalls from one another.

11. The container of claim 1, wherein the bottom and sidewalls are formed of a radio transparent material.

12. A gel formulation for use as an encapsulate for a tissue sample, wherein said gel formulation is a substantially radio transparent epoxy having a maximum setting temperature below about 54° C.

13. The gel formulation of claim 12, having a setting time of not more than about 10 minutes.

14. The gel formulation of claim 13, having a setting time of not more than about 4-5 minutes.

15. The gel formulation of claim 12, comprising a mixture of an epoxy resin, a polyimine and a carrier.

16. The gel formulation of claim 15, wherein the epoxy resin comprises a di-epoxide and the polyimide comprises a branched polymer with imides at terminal ends of the branches.

17. The gel formulation of claim 15, comprising a mixture of poly(ethyleneglycol) diglycidyl ether, poly(ethyleneimine) and water.

18. The gel formulation of claim 15, comprising a mixture of poly(ethyleneglycol) diglycidyl ether, poly(ethyleneimine) and formalin.

19. The gel formulation of claim 15, comprising a mixture of ethylene glycol digycidyl ether epoxide, a branched or endcapped ethyeneimine ethylenediamine polymer, and formalin.

20. A method for preparing a biological sample for pathologic analysis, which comprises soaking the biologic sample in a mixture of a carrier transport solution and formalin solution prior to placing the biologic sample into a gel composition of claim 18.

21. The method of claim 20, further comprising allowing the gel to set, and thereafter slicing the sample, soaking the sliced sample in xylene for a period of time, and then soaking the sliced sample in melted paraffin for a period of time to allow paraffin penetration.

22. A method for preparing a biological sample for pathologic analysis, which comprises soaking the biologic sample in a mixture of a carrier transport solution and formalin solution prior to placing the biologic sample into a gel composition of claim 19.

23. The method of claim 22, further comprising allowing the gel to set, and thereafter slicing the sample, soaking the sliced sample in xylene for a period of time, and then soaking the sliced sample in melted paraffin for a period of time to allow paraffin penetration.
